(19) United States
(12) Patent Application Publication
(10) Pub. No.: US 2023/0061991 A1
(43) Pub. Date: Mar. 2, 2023

(54) LABELLING ARRANGEMENT FOR A MULTI-PART CONTAINER, SYSTEM AND METHOD FOR APPLYING A LABELLING ARRANGEMENT TO A MULTI-PART CONTAINER

(71) Applicant: Schreiner Group GmbH & Co. KG, Oberschleissheim (DE)

(72) Inventors: Mathias FREY, Karlsfeld (DE); Benny GOETZE, Muenchen (DE); Raphael BORY, Freising (DE)

(73) Assignee: Schreiner Group GmbH & Co. KG, Oberschleissheim (DE)

(21) Appl. No.: 17/789,368

(22) PCT Filed: Jan. 21, 2021
(86) PCT No.: PCT/EP2021/051307

§ 371 Date: Jun. 27, 2022

(30) Foreign Application Priority Data
Jan. 24, 2020 (DE) 10 2020 101 702.2

(51) Int. Cl. B65D 55/08; B65D 41/54; A61J 1/06; B65D 41/62

(52) U.S. Cl. CPC B65D 55/0854; B65D 41/54; B65D 55/0863; A61J 1/065; B65D 41/62; A61J 2205/30; B65D 2401/05

(57) ABSTRACT

A labeling arrangement for a multi-part container includes a sleeve-shaped cap element adapted to be coupled to and surround a closure of the container, the cap element having, relative to a longitudinal axis, first and second cap portions and a severing region. The labeling arrangement further includes a fixing label having adjacent first and second label portions. The first label portion is adapted to be attached to the second cap portion, and the second label portion is adapted to be attached to a container body of the container such that the fixation label couples the cap element to the container body, such that when the container with the labeling arrangement is opened, the cap element is separable in the severing region and at least a part of the first cap portion together with a part of the closure is removable from the second cap portion and the container body.

The present invention relates to a labelling arrangement for a multi-part container, which can provide a reliable first-opening indication in a simple and inexpensive manner and which can contribute to reliable tamper protection for the container. The invention also relates to a use of such a labelling arrangement for a multi-part container, and to a system comprising such a labelling arrangement. The invention further relates to a method of applying such a labelling arrangement to a multi-part container.

Labelling arrangements typically comprise a label which may be used for authorization as well as authentication or proof of origin. For example, a labelling arrangement is used when it is necessary to protect ingredients against unauthorized access and to identify when the associated container has been opened. This applies in particular to containers in the pharmaceutical and medical fields, the contents of which are to be protected against manipulation.

It is a task underlying the invention to contribute in a simple and inexpensive manner to reliable marking and secure protection for a multi-part container.

The task is solved by the features of the independent patent claims. Advantageous embodiments are indicated in the respective sub claims.

According to one aspect of the invention, a labelling arrangement for a multi-part container comprises a sleeve-shaped cap element which has a toothed structure on an inner surface and which is adapted to be coupled to and surround an outer surface of a closure of the container by means of the toothed structure. The cap element has, with respect to a longitudinal axis, a first cap portion, a second cap portion, and a separation region. The labelling arrangement further comprises a fixation label having a first label portion and a second label portion adjacent to the first label portion. The first label portion is adapted to be attached to the second cap portion, and the second label portion is adapted to be attached to a container body of the container such that the fixation label couples the cap element to the container body. The labelling arrangement is thus adapted so that, when the container applied with the labelling arrangement is opened, the cap element is separable in the separation region and at least a part of the first cap portion is removable together with a part of the closure from the second cap portion and the container body.

By means of the described label assembly, among other things, a reliable and cost-effective sealing solution for syringes can be realized. The labelling arrangement enables a secure sealing of, for example, primary packaging or vessels in the pharmaceutical field, such as syringes, injection vials or vials, whereby an intactness of a medicament packaging can be guaranteed or indicated. The labelling arrangement prevents unintentional reuse of a suitably labelled primary packaging after its use and clearly visibly and reliably indicates an initial opening of the primary packaging. In this way, the labelling arrangement also counteracts manipulation of the primary packaging and provides evidence of the initial opening. The first-opening protection which can be set up by means of the labelling arrangement is particularly suitable for syringes which are provided with a Luer-lock closure.

According to a preferred embodiment of the labelling arrangement, the second cap portion is arranged adjacent to and geometrically formed in coordination with the body of the container with respect to a state of the labelling arrangement applied to the container, and has a predetermined circumferential geometry. Such a circumferential geometry may be oval, angular or round. In particular, the cap element can be rotationally symmetrical with respect to the longitudinal axis in coordination with the angular, so that at least the second cap portion has a predetermined diameter corresponding to a diameter of the container body and an outer surface of the second cap portion can be arranged flush with an outer surface of the container body.

The cap element forms, for example, a sleeve which is open at the top with respect to the longitudinal axis and which is designed to be closable, in particular in cooperation with a lid element provided for this purpose. When the container is opened, the cap element or the first cap portion is then pressed against an outer surface of the closure and is separated from the second cap portion by means of pulling and/or turning and is removed from the container body together with a part of the closure. In addition, the cap element may be configured to provide a narrow gap or space between the cap element and the closure therein. Manipulation or an attempt to open the cap by reaching into the narrow gap from above is therefore not possible, or only possible under difficult conditions. Preferably, the cap element is configured to at least partially contact an outer surface of the closure.

In the context of this description, terms such as “top” and “bottom” refer to an operational arrangement or application of the labeling arrangement and the container. This also applies to terms such as “head” and “body”, where the head is typically to be arranged at the top and the body is typically to be arranged at the bottom. The closure of the container forms, for example, an upper portion of an injection vial or syringe, and includes, for example, a head portion and a threaded portion that are screwable together. The head portion is unscrewed and removed from the threaded portion to open the container. The container body forms a lower portion of the injection vial or syringe, and realizes a vessel for holding and storing a predetermined content.

The container forms a primary receptacle to which the labeling arrangement is predeterminedly attached as a secondary component. The cap element may therefore also be referred to as a secondary cap, which is attached to the container and surrounds the closure. The labeling arrangement is suitable for use on a syringe, which is a multi-part container with a syringe head and a syringe body. However, the principle is also applicable to other pharmaceutical packaging, such as injection vials or vials. In particular, the described labeling arrangement also enables subsequent sealing of prefilled syringes. By means of the cap element, an adapter for the closure of the container can be realized, which in particular can establish a geometry compensation between syringe head and syringe body. Therefore, the labeling arrangement also contributes to a simple, automated and process-safe labeling capability of such containers. Typically, the threaded portion of the closure is formed smaller than the head portion or the container body. In the case of rotationally symmetrical containers, such as a syringe, this refers in particular to a diameter of the respective container parts. In addition, a threaded portion of a Luer-lock syringe usually has a tapered threaded portion, which can only be labeled with increased effort. By means of the surrounding cap element, the diameter of the head section of the syringe can be selectively enlarged and, for example, brought into line with a diameter of the body section. In this way, the fixation label can be applied particularly easily and reliably to the container adapted with the cap element and, in cooperation with the second cap portion, fix the threaded portion of the syringe. In this way, undesirable rotation of the threaded portion, for example when the container is opened or when a syringe needle is inserted, can be specifically counteracted.

According to a further preferred embodiment of the labeling arrangement, the first and/or the second cap portion have, with respect to the longitudinal axis, on a respective inner surface a circumferential contour which forms a negative shape with respect to a circumferential contour on a respective outer surface of the closure. By means of such an inverse shaping of the inner contour of the cap element, a particularly reliable hold on the closure of the container can be established. The cap element forms a form-fitting secondary cap which, as an adapter for the primary cap or closure, compensates for geometry and provides a stable and firm hold on the container.

In particular, a wall of the second cap portion bounded by an inner surface and an outer surface may be cone-shaped with respect to the longitudinal axis and taper toward the first cap portion. Particularly preferably, the outer surface of the second cap portion is cylindrical in shape and while the inner surface of the second cap portion tapers in a funnel shape towards the body of the container. In other words, the second cap portion has a thicker wall in a lower region facing the container body in an applied state than in an upper region facing away from the container body in an applied state.

According to a particularly preferred embodiment, the labeling arrangement further comprises a lid element that is coupleable to the first cap portion and that is configured to be attached to the closure of the container and to couple the first cap portion to the closure and to cover an upper surface of the closure. In particular, the lid element is configured to be coupled to the first cap portion and/or the closure in a form-fitting, force-fitting and/or material-fitting manner. In particular, the lid element and the first cap portion can be designed in such a way that they can be coupled to one another by means of welding and/or adhesive bonding.

In particular, the interlocking toothed structure of the cap element is configured to engage existing recesses on the outer surface of the closure or to accommodate the surface structure on the outer surface of the closure. The toothed structure comprises, for example, one or more interlocking elements which form a positive coupling with the closure of the container in the form of engaging or hooking projections, so that a reliable holding force is established between the cap element and the closure with respect to a longitudinal axis of the cap element.

Alternatively or additionally, for example, the first cap portion comprises on an inner surface a contour having an interlocking structure predefined in coordination with a contour having an interlocking structure on an outer surface of the lid element. For example, the lid element has a protruding circumferential portion that can engage a corresponding circumferential recess or groove on an inner surface of the first cap portion to establish a latching coupling. The interlocking structures are formed complementary to each other, such that, for example, one interlocking structure includes an interlocking element configured to engage a recess of the other interlocking structure when the cap element is attached to the closure. The interlocking element or elements are, for example, each in the form of a vertical and/or horizontal engagement hook, which is designed to form a positive coupling, so that a rotational holding force and/or a holding force in the direction of the longitudinal axis is established between the cap element and the closure with respect to a longitudinal axis of the cap element. Interlocking of the cap element with the closure is then effected by rotating the cap element or the respective cap parts until they engage in a surface structure on the closure and/or the lid element.

A respective interlocking toothed structure can be provided on the first and/or the second cap portion and can contribute to an easier opening of the container by means of a rotational movement, in which a force transmission is initiated due to the rotationally fixed form closure between the cap element and the closure with or without the lid element. When the container is opened, the retention force of the closure on the container body must then be overcome by a rotary movement. As an alternative to a latching hook, a toothed element of a toothed structure can be designed in the form of a web or pin with respect to a longitudinal axis of the cap element and be set up to form a positive coupling with the first part of the container, so that a holding force is set up in the radial direction about the longitudinal axis with respect to the longitudinal axis between the cap element and the closure.

The lid element can be designed as a flat disc and, in particular, have a predetermined surface structure on a circumferential outer side that enables reliable coupling with the cap element. Furthermore, alternatively or additionally on an inner side or an underside of the cap element, a surface structure may be specifically predetermined in order to form a reliable and stable connection with an upper side of the cap.

According to a further embodiment of the labeling arrangement, the lid element has a sleeve portion which extends between the cap element and the closure with respect to a state of the labeling arrangement applied to the container. In this way, a particularly reliable hold can be established between the first cap portion and the lid element, which also contributes to a reliable transmission of force to the closure. Compared to a disc-shaped lid element, the circumferential sleeve portion provides a larger coupling surface to the first cap portion and can thus contribute to a particularly secure and reliable hold.

According to a further embodiment of the labeling arrangement, the cap element and/or the lid element is formed as a shrink film element. The cap element and the lid element can, for example, be formed in one piece and form a type of film pocket which is slipped over the closure of the container and, for example, bonded to the container. Alternatively or additionally, such a foil pocket can be fixed to the container by means of the fixing label. By means of the action of thermal radiation, the cap element and/or the lid element can be selectively shrunk and adapted to fit precisely to an outer shape of the closure. In particular, such a foil element provides a relatively low tear resistance, so that the foil element can be easily torn and severed. For example, the film element is formed as an acetate foil and does not require a separate perforation or other weakening structure to allow easy severing of the cap element.

According to a further embodiment of the labeling arrangement, the first and second cap portions are connected to each other and the separation region is formed between the first and second cap portions with respect to the longitudinal axis, such that when the container applied with the labeling arrangement is opened, the cap element is predeterminedly severable in the separation region and the first cap portion is removable together with a portion of the closure from the second cap portion and the container body. In particular, the cap element may include a severing element in the form of a perforation and/or in the form of a plurality of connecting webs in the severing region, each allowing controlled severing along the severing element.

The severing region of the cap element may therefore be predetermined in that the first and second cap portions form two separate parts that are coupled together when the labeling arrangement is attached to the container. When the container is opened, the first cap portion is then completely or partially removed along with a portion of the closure. Alternatively, the cap portions may be interconnected or formed integrally with each other and realize a coherent cap element which is placed on the container. The severing region may also be referred to as the severing area, as it allows for selective severing, in particular of a coherent cap element. In this context, it is not absolutely necessary that the two cap elements are separated exactly from each other. It is much more possible that a section of the upper, first cap portion is separated from the lower, second cap portion and another section of the first cap portion remains on the second cap portion. This may be the case, for example, if the first cap portion is implemented as a foil element and tears when opened and remains in sections on the container or the container body.

If, for example, the cap element has connecting webs connecting the upper, first cap part to the lower, second cap part, the connecting webs break open when the container is opened by pulling and/or turning on the attached cap element and allow the first cap portion or at least a section thereof to be removed from the remaining components together with the part of the closure coupled therein. Such broken connecting webs may further serve as opening evidence.

Furthermore, the fixation label may also have a severing region disposed between the first label portion and the second label portion, such that when the container applied with the labeling arrangement is opened, the fixation label is predeterminedly severable in its severing region and the first label portion together with the first cap portion and the head portion of the closure are removable from the second label portion and the container body of the container.

Preferably, a severing element in the form of one or more perforations is disposed in the severing region of the fixation label. Alternatively or additionally, a tear strip may be provided in the severing region of the fixation label. By means of a tear strip, the fixation label can be specifically cut through when the container is opened. Thus, a controlled severing of the fixation label along the predetermined perforation or the tear strip can also be performed in a simple and cost-effective manner. In particular, a perforation can also be combined with punch-outs or branches upwards and/or downwards in order to leave clearly visible damage after the fixation label has been cut and the container opened. For example, the perforation may be serrated to provide a clearly visible indicator of initial opening. Alternatively or additionally, the fixation label may include a film or foil element in the severing or separation area that has a predetermined tear strength.

Preferably, the labeling arrangement comprises an adhesive layer arranged on an underside of the fixation label so that the fixation label can be easily and reliably applied to the container by means of adhesive. Insofar as the applied fixation label has a severing region and extends to the upper, first cap portion, an adhesive-free area is preferably formed in the severing region. Thus, easier severing of the fixation label and removal of the first label portion is enabled. A force required to separate the cap element and/or the fixation label is reduced compared to a fully adhesive fixation label, and an opening dynamic of the container applied with the fixation label is improved.

Preferably, an outer surface of the cap element is predeterminedly roughened and/or has a microstructure that contributes to a particularly reliable adhesion of the fixation label. For example, an outer surface of the second cap portion is formed in a coordinated manner for the adhesion of a fixation label provided with pressure-sensitive adhesive. This can be achieved by selecting a plastic having a high surface energy and/or roughness of the surface. The outer surface of the cap element may also be divided into two parts, wherein the lower, second cap portion may be adapted for adhesion with the fixation label as described, and the upper, first cap part may have, for example, a corrugation which enables gripping handling for carrying out an opening rotary movement. The fixation label may also provide some roughness or grip and contribute to an improved feel of the container provided with the labeling arrangement. Beneficial surface features can also be realized, for example, with anti-slip lacquers, by means of printed tactile elements or surface micro-structuring, which enable a more secure grip of the cap element and/or the fixation label.

The fixation label can be single-layered or multilayered. For example, it can be a wrap-around label or an all over wrap-around label that encloses a circumference of the container relative to its longitudinal axis. Alternatively, the fixing label can also be designed in terms of its geometry in such a way that it only partially covers a circumference of the container. In terms of a height or length, the fixation label may partially or completely cover the container from the bottom to the top or extend from a foot-side end of the container body to a head-side end of the closure. Alternatively, the fixation label may extend beyond a height or length of the container in addition to the side on the attached cap element and the lid, if present.

According to a further embodiment of the labeling arrangement, the second cap portion comprises a latching hook which is adapted to form a positive coupling with the closure of the container, such that with respect to the longitudinal axis of the cap element, a holding force can be established between the cap element and the closure in the direction of the longitudinal axis. Such a latching hook can be formed, for example, as a circumferential protruding portion on a lower section of the second cap portion, which in an applied state faces the container body and engages and latches on an underside of the closure in a gap between the closure and the container body. Thus, a reliable hold of the cap element on the closure or on the container can be further contributed to.

According to a further embodiment of the labeling arrangement, the severing region is formed in coordination with the container in a region of the cap element which, in an applied state of the labeling arrangement on the container, is associated with a transition between a head portion and a threaded portion of the closure. A sufficiently forceful turning and/or pulling of the cap element simultaneously results in a predetermined separation of the labeling arrangement. However, the severing region may also be arranged in other areas which allow separation of the cap element and, if necessary, also of the fixing label when the container is opened. Furthermore, a severing element, for example in the form of a perforation or a tear strip, may be provided in the severing region, which enables controlled severing of the respective components.

According to a further preferred embodiment, the labeling arrangement comprises an opening detection element arranged in the severing region of the cap element and configured to indicate a removal of at least a portion of the first cap portion together with the part of the closure from the container body upon an opening of the container applied with the labeling arrangement. Such an opening detection element may be implemented, for example, in the form of a detachable section of the first cap portion and, if applicable, also of the first label portion of the fixing label. Provided that the two cap parts form adjacent sections of the cap element between which a perforation is provided, or if connecting webs are formed between the cap parts, these elements can serve as an opening detection element. After the container has been opened, broken web sections or a torn perforation remain on the upper, first cap portion and the lower, second cap portion, so that, similar to a water bottle cap, it can be seen that an opening of the container has already taken place.

According to a further embodiment, the cap element comprises a recess which penetrates a wall of the cap element so that the possibility of a fluid exchange, for example during a sterilization process, between an inner space and an outer space of the cap element is established. Such a fluid opening may, for example, be provided in an upper or a lower region in the cap element and allow for fluid exchange. Preferably, a plurality of fluid openings are provided to allow gas and/or liquid to pass therethrough. By means of a penetrating recess, a space between the primary cap and the attached cap element can be ventilated and help to ensure that an undesired media entrapment in the space does not cause adverse effects on the container and its contents as well as on the attached labeling arrangement.

The cap element can be made of a material that allows it to be seen through, thus enabling visual inspection of the closure. For example, the cap element is formed from a transparent plastic. This could be particularly useful for the lower, second cap part of the cap element, which encloses a Luer thread of a syringe, for example. Thus, inspection of the syringe tip from the outside is possible, for example, to check whether air bubbles have collected in a container neck.

By means of the labeling arrangement, a reliable and secure sealing of the container can be set up, which counteracts unauthorized manipulation of the container contents and clearly indicates a first use or a first opening that has already occurred. The fixation label can have an imprint or lettering as a characterizing element. In addition, the fixation label contributes to a reliable retention of the threaded portion of the closure coupled to the second cap portion, which in turn is connected to and coupled by the fixation label to the container body.

According to a further aspect, the invention comprises a use of an embodiment of the described labeling arrangement for a container divisible into a plurality of parts comprising a container body and a closure.

According to a further aspect of the invention, a system comprises a container divisible into a plurality of parts comprising a container body and a closure coupled to the container body. The system further comprises an embodiment of the previously described labeling arrangement applied to the container such that the cap element surrounds the closure, and the first cap portion is associated with a head portion and the second cap portion is associated with a threaded portion of the closure. Further, the first label portion of the fixation label is attached to the second cap portion and the second label portion of the fixation label is attached to the container body so that the fixation label couples the cap element to the container body.

In that the use and the system relate to or comprise an embodiment of the described labeling arrangement, the described properties and features of the labeling arrangement are also disclosed for the use and for the system, and vice versa.

In accordance with a further aspect of the invention, a method of attaching a labeling arrangement to a multi-part container comprises providing a container divisible into a plurality of parts comprising a container body and a closure coupled or coupleable to the container body. The method further comprises providing the labeling arrangement with a sleeve-shaped cap element and a fixation label, the cap element having a first cap portion, a second cap portion, and a severing region. The fixation label has a first label portion and a second label portion adjacent to the first label portion. The method further comprises coupling the cap element to the container body and to the closure of the container, such that the cap element is attached to the container body and surrounds the closure. The method further comprises attaching the fixation label to the container by attaching the second label portion to the container body, and attaching the fixation label to the cap element by attaching the first label portion to the second cap portion. Thus, the fixing label couples the cap element to the container body so that when the container applied with the labeling arrangement is opened, the labeling arrangement is separable in the severing region and at least a portion of the first cap portion is removable from the second cap portion and the container body together with a portion of the closure.

By means of the described application or assembly method, it is possible to use the properties and features provided by the labeling arrangement for secure protection and reliable identification of the container. Among other things, this makes it possible to provide a clearly recognizable proof of first opening and also contributes to improved handling when opening and using the container by fixing the threaded part of the closure. In that the method relates to an application or assembly of an embodiment of the described labeling arrangement, the described properties and features of the labeling arrangement are also disclosed for the method, and vice versa.

According to a further embodiment of the method, coupling the sleeve-shaped cap element to the container body and to the closure comprises placing the cap element on the container body and inserting the closure into the cap element. In this regard, the closure may first be inserted into the cap element to form a mated assembly that is subsequently placed on the container body. Alternatively, the insertion of the closure into the cap element may be performed subsequent to the placement of the cap element onto the container body. Further, the closure may be provided in individual parts, at least including a head portion and a threaded portion, and assembled prior to coupling. Furthermore, the closure may be provided already attached to the container body, such that the method may comprise a step in which the closure is first removed from the container body, coupled to the cap element, and subsequently reattached to the container body together with the cap element. An assembly sequence with respect to an arrangement and assembly of the described components of the labeling arrangement may thus vary, wherein a complete labeling of the container with the fixation label may take place only after at least the second cap portion has been attached to the container body.

A preferred further embodiment of the method takes into account that the labeling arrangement comprises a lid element, which is placed on the first cap portion of the cap element and/or on a head part of the closure, such that the lid element covers an upper side of the head part of the closure and couples the first cap portion with head part at least during an opening process of the container, thereby enabling a force transmission.

In accordance with a further embodiment of the method, the coupling of the cap element and/or the lid element to the closure of the container comprises forming a respective form-fitting, force-fitting and/or material-fitting connection. Such couplings can be formed in particular by means of interlocking, by means of bonding, by means of welding and/or by means of the action of thermal radiation.

The labeling arrangement attached to the container enables reliable first-opening indication, especially for Luer glass syringes, and contributes to improved labeling capability. In the following, the described labeling arrangement is explained again using the example of a container in the form of a two-part syringe, which can be realized in particular as a plastic syringe (e.g. COC/COP) or glass syringe with Luer-lock thread/adapter. However, the properties and features can also be transferred with respect to other multi-part containers, such as injection vials.

Preferably, the labeling arrangement comprises the fixation label and a two-part secondary closure comprising the sleeve-shaped cap element and the lid element, which are particularly adaptable to an application for Luer closures on glass syringes. The cap element may be configured to accommodate a conventional shape of a Luer closure, which tapers toward the glass syringe so that a conventional fitted cap is not flush with the periphery of the glass syringe. As a result, wrinkle-free labeling of the syringe down to the cap is not possible. By means of the described labeling arrangement, circumferential uniformity between the syringe body and the syringe cap can be established in a simple and cost-effective manner. In addition, an outer circumference of the glass syringe with the secondary closure provided by the labeling arrangement is formed to be only slightly larger than without such a cap element, so that the syringes can be easily placed in associated storage containers, so-called nests.

In particular, the described labeling arrangement may beneficially affect a manufacture or assembly of the labeling arrangement to the container due to its design structure. The closure of the syringe can be provided with the provided secondary closure of the labeling arrangement without the syringe body, and then sterilized and subsequently only plugged onto the syringe or syringe body. This offers logistical advantages at the pharmaceutical manufacturer and its upstream supplier and can have a beneficial effect on an assembly process.

The sleeve-shaped cap element can be formed with very thin walls and can be designed to be very flexible or expandable. In a lower region, which faces the syringe body in an assembled state, the cap element has a smaller diameter than in an upper region. Thus, the Luer thread can be enclosed by means of the cap element in such a way that it is flush with the glass syringe or its syringe body. The formed flush transition between the syringe body and the Luer thread can now be labeled with the fixation label without folds, so that a reliable anti-twist protection of the Luer thread relative to the syringe body can be set up.

A lid element may be provided at an upper end of the cap element, for example to be placed on a recess of the closure of the syringe, and to mechanically contact the closure and/or the cap element. When the syringe is opened, a force is applied to the upper portion of the sleeve-shaped cap element. Due to the connection between the cover element and the closure of the syringe and due to the fixation of the lower, second cap portion to the syringe glass body, a predetermined separation of the cap portions from each other, for example by breaking existing retaining webs of the cap element, can be initiated and represent an initial opening indication.

In the following, embodiments of the invention are explained with reference to schematic drawings. They show:

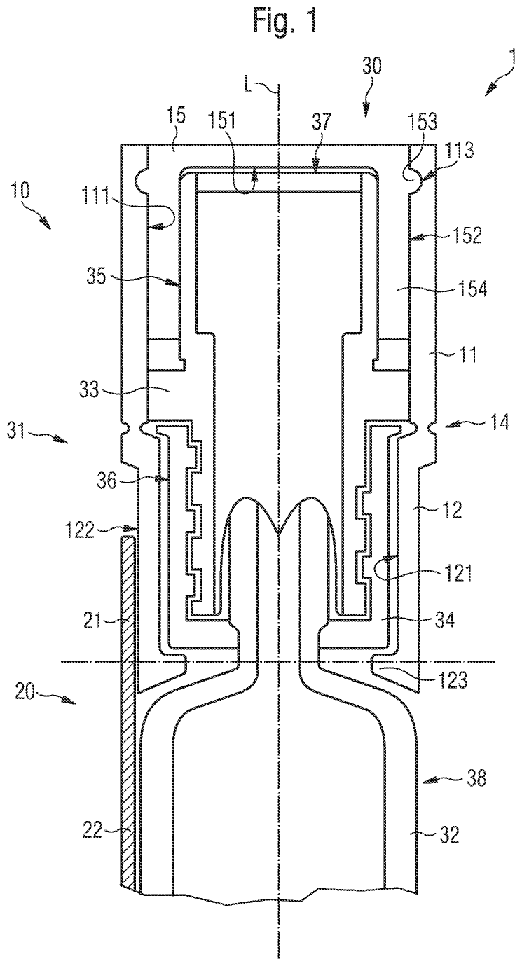

FIG. 1 an embodiment of a system with a multi-part container and a labeling arrangement attached thereto,

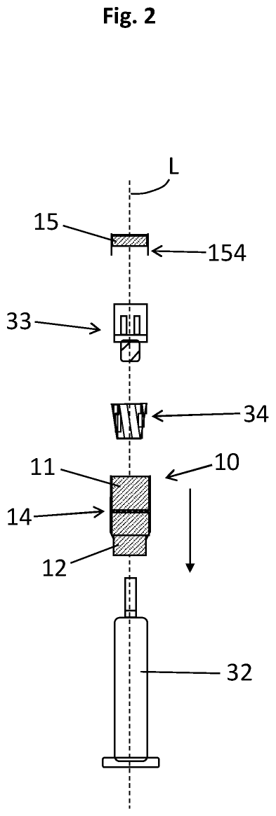

FIGS. 2-10 a further embodiment of the labeling arrangement,

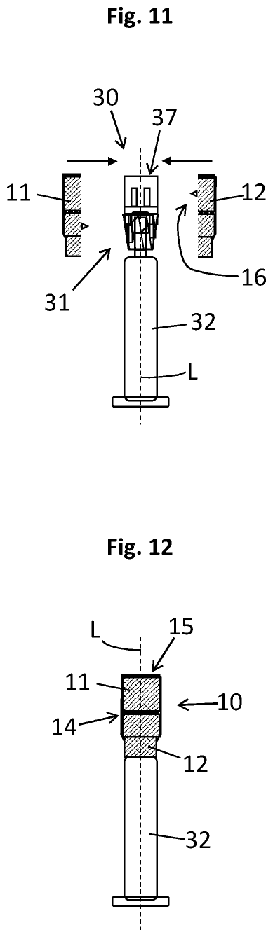

FIGS. 11-12 a further embodiment of the labeling arrangement,

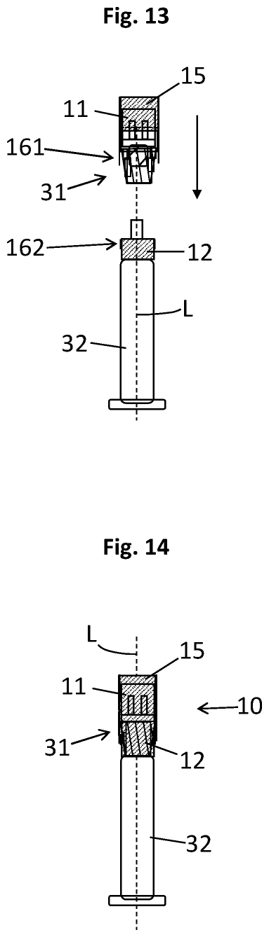

FIGS. 13-14 a further embodiment of the labeling arrangement,

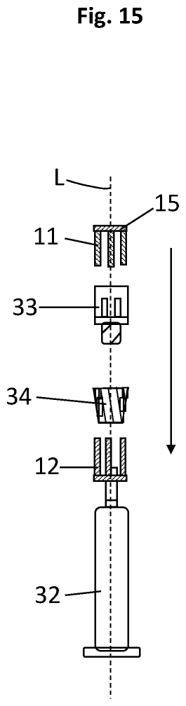

FIGS. 15-17 a further embodiment of the labeling arrangement,

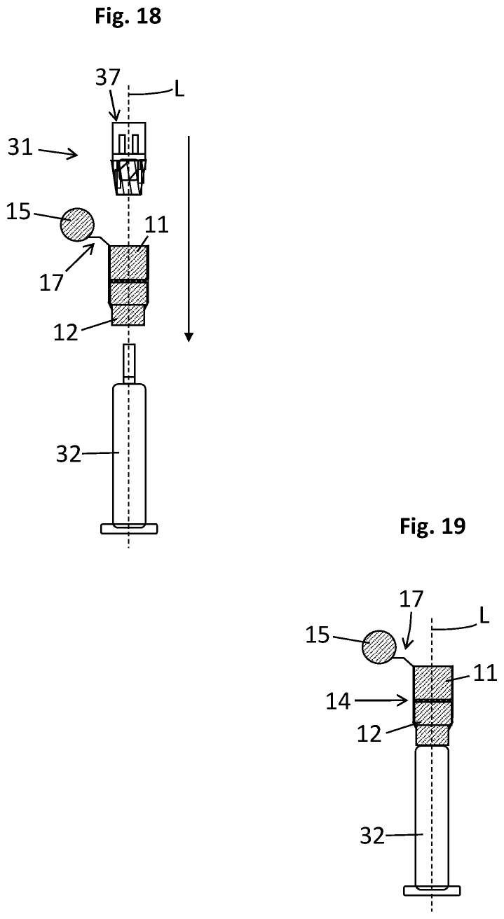

FIGS. 18-19 a further embodiment of the labeling arrangement,

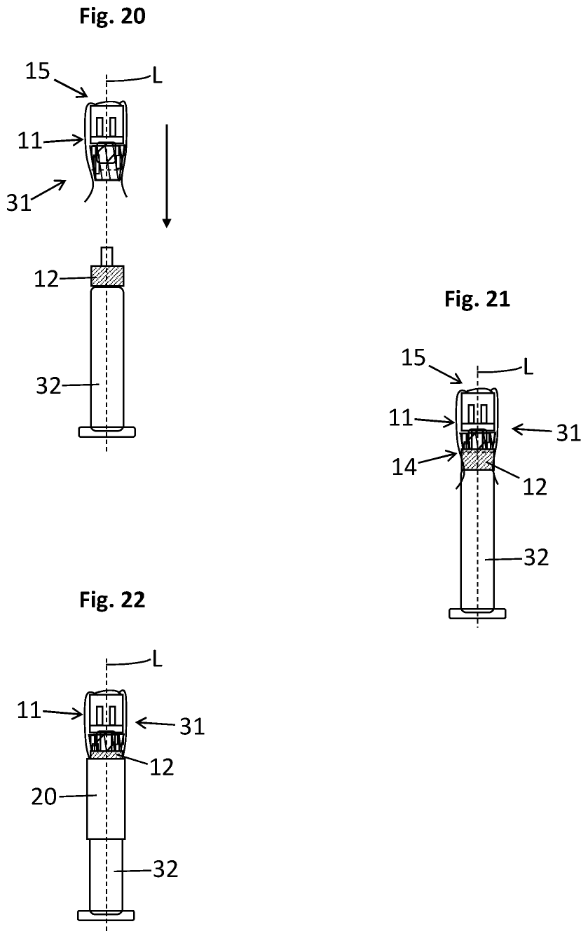

FIGS. 20-22 a further embodiment of the labeling arrangement,

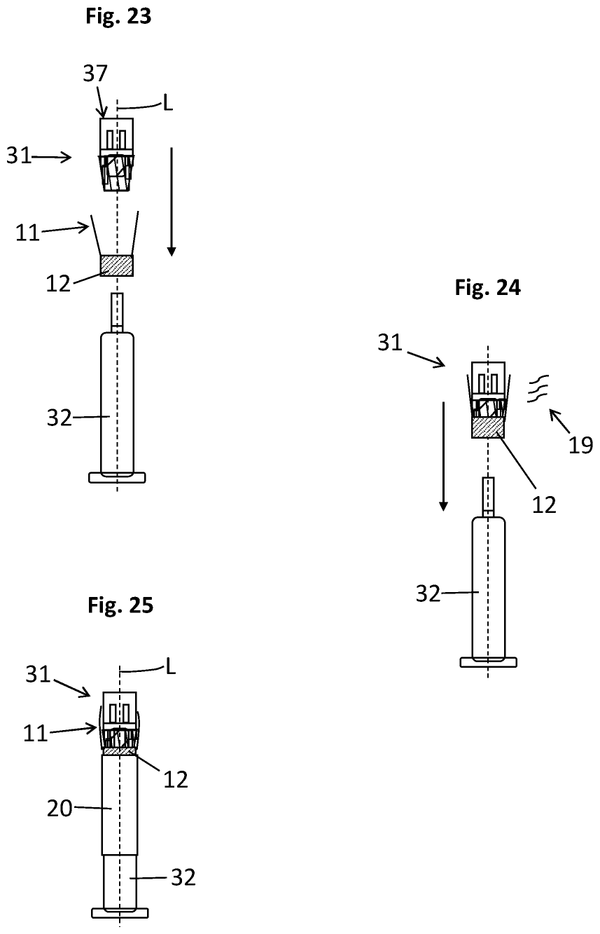

FIGS. 23-25 a further embodiment of the labeling arrangement,

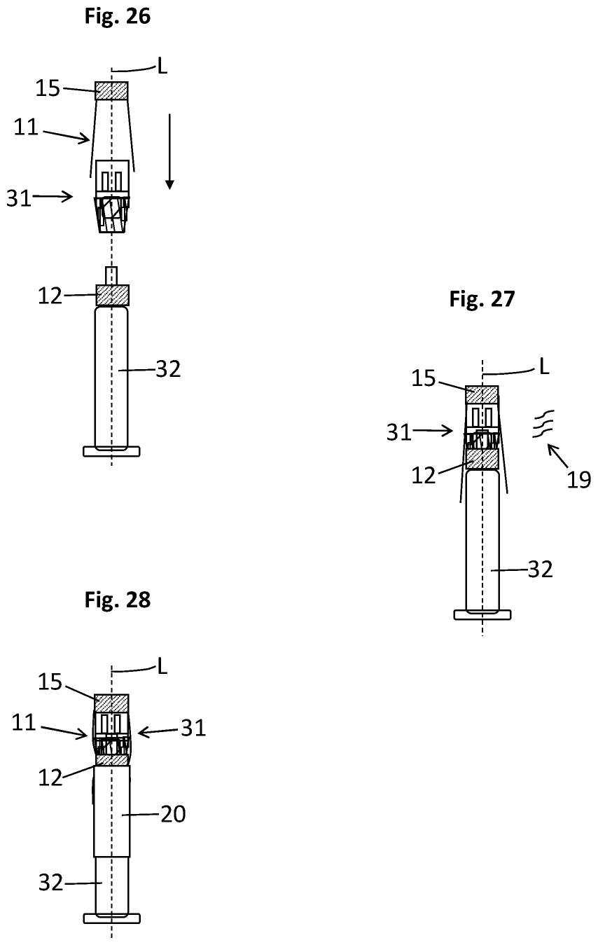

FIGS. 26-28 a further embodiment of the labeling arrangement,

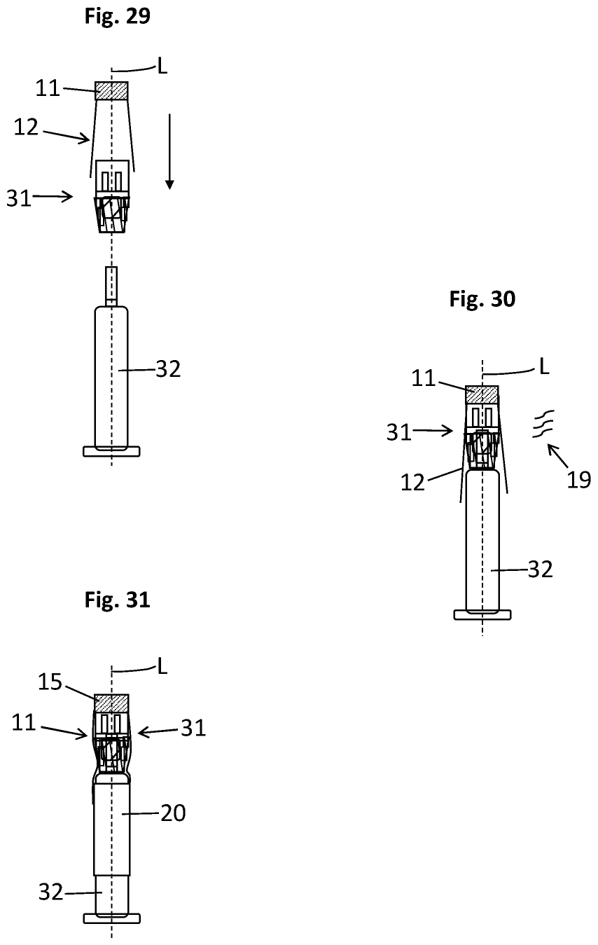

FIGS. 29-31 a further embodiment of the labeling arrangement, and

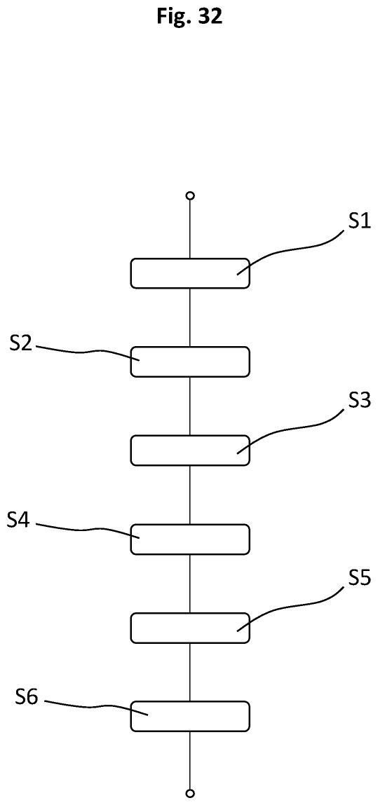

FIG. 32 a flow diagram for a method of applying the labeling arrangement to a multi-part container.

Elements of the same construction and function are marked with the same reference signs across the figures. For reasons of clarity, not all of the elements shown in all of the figures are identified with the corresponding reference signs, possibly.

FIG. 1 shows a schematic sectional view of a system with a multi-part container 30 and a labeling arrangement 1 attached thereto, which enables reliable and secure initial opening verification for the container 30 and also contributes to improved labeling capability and handling of the container 30. The container 30 comprises a closure 31, by means of which a container body 32 of the container 30 can be closed. The closure 31 comprises a threaded portion or threaded part 34 and a head portion or head part 33, which is screwable to the threaded part 34.

The labeling arrangement 1 comprises a cap element 10 having a first cap portion 11 and a second cap portion 12, which are formed adjacent to each other and between which a severing region 14 is arranged. With respect to a longitudinal axis L of the labeling arrangement 1 and/or the container 30, the first cap portion 11 forms an upper cap portion and the second cap portion 12 forms a lower cap portion. The cap element 10 is formed in a sleeve shape and has a toothed structure 113 on an inner surface 111, which cooperates with a toothed structure 153 of a lid element 15. The cap element 10 is configured to be coupled to and surround the closure 31 of the container 30. The cap element 10 further comprises an interlocking structure on an inner surface 111 and/or 121 of the first and/or second cap portion 11, 12 with which it is positively and/or frictionally coupleable to an outer surface 35 and/or 36 of the closure 31. Thus, a rotational retention force is established between the cap element 10 and the closure 31 with respect to the longitudinal axis L.

According to the embodiment illustrated in FIG. 1, the second cap portion 12 further comprises a circumferential engagement hook 123 that engages a gap between the cap element 10 and the container body 32, and thus a further retaining force is established between the cap element 10 and the closure 31 in the direction of the longitudinal axis L.

The labeling arrangement 1 further comprises a fixing label 20 having a first label portion 21 and a second label portion 22 adjacent thereto. The first label portion 21 is adapted to be attached to the applied cap element 10 in a state of the fixation label 20 applied to the container 30. In particular, the first label portion 21 is adapted to be attached to the second cap portion 12 such that the fixation label 20 couples the cap element 10 to the container body 32 of the container 30. The second label portion 22 is adapted to be secured to the container body 32. In particular, this can be done by adhering the fixation label 20 to an outer surface 122 of the second cap portion 12 and an outer surface 38 of the container body 32 by means of an adhesive layer. The two label portions 21 and 22 of the fixation label 20 preferably form mutually adjacent portions of a common material web.

The two cap portions 11 and 12 are integrally formed, for example, as a common plastic component and have a deliberately introduced weakening structure, for example in the form of a circumferential indentation, perforation and/or predetermined breaking point, in the severing region 14, so that, when the container 30 applied with the labeling arrangement 1 is opened, the cap element 10 can be severed in a predetermined manner in the severing region 14 and the first cap portion 11 or at least a part thereof can be removed together with the head part 33 of the closure 31 from the second threaded part 34 of the closure 31.

Furthermore, the labeling arrangement 1 according to FIG. 1 comprises the lid element 15 which is couplable to the first cap portion 11 by means of the interlocking toothed structure 153. The lid element 15 is designed to be attached to the closure 31 of the container 30 and to cover an upper side 37 of the closure 31. In particular, the lid element 15 serves to transmit force during an opening process from the cap element 10 to the closure 31 and/or from the first cap portion 11 to the top part 33. Preferably, the lid element 15 is configured to be coupled to the first cap portion 11 and/or the closure 31 in a form-fitting, force-fitting and/or material-fitting manner. For example, the lid element 15 may be mechanically interlocked with the first cap portion 11, as shown, by means of the cooperating interlocking structures 113 and 153 and/or may be attached to the top surface 37 of the head portion 33 by means of adhesive.

The interlocking structure 113 of the first cap portion 11 is formed as a circumferential recess or groove on the inner surface 111 of the cap element 10 in coordination with the interlocking structure 153 on an outer surface 152 of the lid element 15, which is complementary to the recess in the form of a bead or protruding annular protrusion. Alternatively or additionally, the first cap element 11 may also comprise a protruding region or one or more toothed elements which engage in corresponding recesses on the lid element 15, so that a particularly stable and reliable retaining force can be set up between the cap element 10 and the closure 31 with respect to the longitudinal axis L.

The lid element 15 has a sleeve section 154, which is arranged between the cap element 10 and the closure 31 with respect to the longitudinal axis L. In this way, a particularly reliable hold can be established between the first cap portion 11 and the lid element 15, as well as between the lid element 15 and the head part 33 of the closure 31, which allows for a reliable transmission of force when the container 30 is opened. Alternatively, the lid element 15 can also be formed as a flat disc (see FIGS. 18 and 19) and have a predetermined surface structure on a circumferential outer side, which enables reliable coupling with the cap element 10.

By means of the described labeling arrangement 1, among other things, a reliable and cost-effective sealing solution for syringes with a Luer-lock thread can be realized. The labeling arrangement 1 enables secure sealing of, for example, primary packaging in the pharmaceutical field, such as injection vials or vials, whereby an intactness of a medicament package can be guaranteed or at least clearly indicated. As will be explained below with reference to further FIGS. 2 to 32, the labeling arrangement 1 can prevent unintentional or unauthorized reuse of a suitably labeled primary packaging after its use, or at least clearly visibly and reliably indicate that an initial opening of the primary packaging has occurred. Thus, by means of the labeling arrangement 1, a manipulation of the primary packaging is also counteracted or indicated by a first opening proof.

In the following, the labeling arrangement 1 is described predominantly in cooperation with a syringe as a container 30, which has a syringe head realized by the closure 31 and a syringe body realized by the container body 32. However, the principle is also applicable to other pharma packaging, such as injection vials or vials. The container 30 may be configured as a glass syringe or plastic syringe 30, which for opening purposes comprises the removable head part 33 arranged together with the threaded part 34 on or at the syringe body 32. In the context of this description, terms such as “top”, “bottom”, “head” and “body”, refer to an operational arrangement or application and orientation of the labeling arrangement 1 and the container 30. The closure 31 of the container or syringe 30 thus forms a top part or head of the syringe 30, which is at least partially removed for opening the syringe 30. The body of the container or syringe 32 then forms a lower portion of the syringe 30, which realizes a vessel for receiving and storing a predetermined content.

The first label portion 21 of the fixation label 20 is associated with the closure 31 or the cap element 10 arranged therearound and can therefore also be referred to as the upper label portion 21. The second label portion 22 of the fixation label 20 is associated with the lower syringe body 32 and can therefore also be referred to as the lower label portion 22.

The cap element 10 has a contour on the inner surface 111 and/or 112, which is formed in a predetermined manner in coordination with a contour on the outer surface 35 and/or 36 of the closure 31. Provided that the lid element 15 comprises the sleeve portion 154, the inner surface 111 of the first cap portion 11 may be formed in coordination with a contour on the outer surface 152 of the sleeve portion 154. An inner surface 151 of the lid element 15 is preferably also formed to match the outer surface 35 and/or the top surface 37 of the head portion 33 with respect to its contour. Particularly preferably, the contours of the components that adjoin each other are formed such that they form partially or completely complementary geometries. Preferably, the second cap portion 12 has a conical inner geometry that realizes a negative shape to a circumferential contour at the outer surface 36 of the threaded part 34.

The threaded portion 34 of a Luer-lock thread extends conically in the direction of the syringe body 32 (see FIGS. 2 to 4), so that it has a smaller diameter at a lower end than at an upper end. Accordingly, the second cap portion 12 preferably has a conical geometry in which a wall of the second cap portion 12 is thicker at a lower end than at an upper end. Thus, a reliable positive fit of the cap element 10 with the closure 31 can be established. A wall thickness of the cap element 10 is preferably also formed to match any difference in diameter between the head portion 33 and the threaded portion 34 of the closure 31. In this way, the cap element 10 can form a geometry compensation between the Luer-lock closure 31 and the syringe body 32 as an adapter. In particular, the geometries and elements described refer to rotationally symmetrical embodiments with respect to the longitudinal axis L, as is common in syringes.

FIGS. 2 to 10 show an embodiment example of the labeling arrangement 1 in various positions of assembly or attachment to the syringe 30. Such an assembly procedure can be carried out according to the flowchart illustrated in FIG. 32 for a procedure for applying the labeling arrangement 1 to the container 30.

FIG. 2 shows in a schematic side view the individual parts of the system, which can be provided individually or partially coupled in a step S1. With an arrow pointing downwards it is indicated that in a further step S2 a coupling of the components cap element 10 and syringe body 32 can take place.

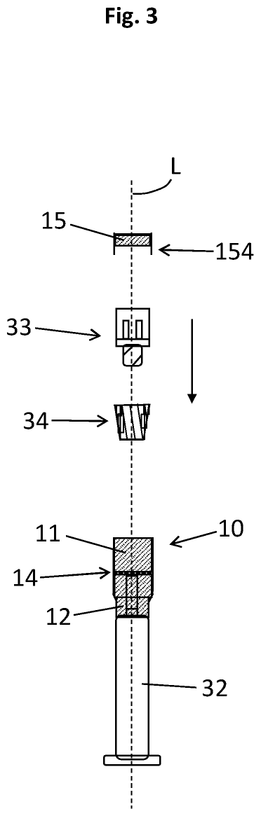

FIG. 3 shows the coupling that has taken place, in which the sleeve-shaped cap element 10 is placed on the syringe body 32. A downward pointing arrow indicates a next possible coupling. In a step S3, the threaded part 34 and the head part 33 can be coupled, in particular screwed together, if the closure 31 is not already provided coupled.

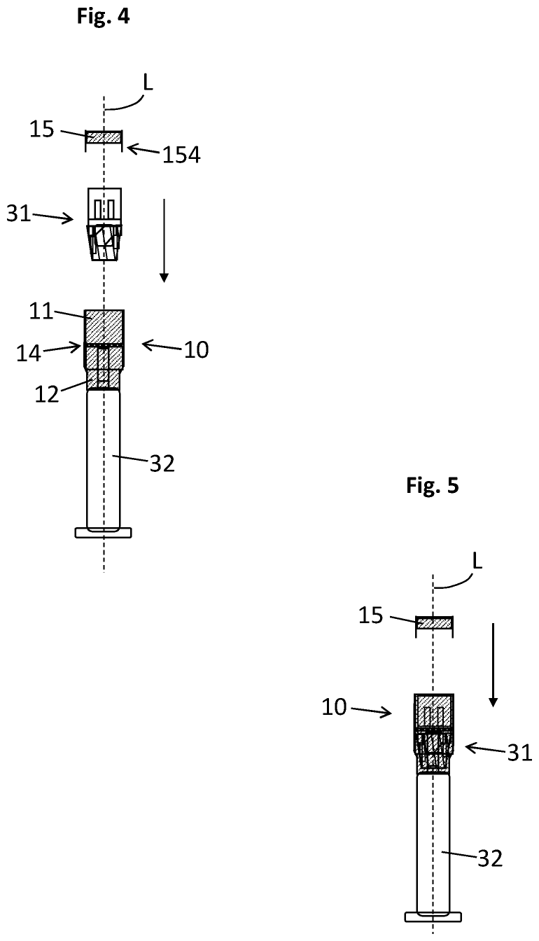

FIG. 4 shows the coupling that has taken place, in which the head part 33 is screwed into the threaded part 34. With an arrow pointing downwards, a next possible coupling is indicated. In a step S4, the closure 31 can now be inserted into the sleeve-shaped cap element 10. In particular, when the closure 31 is inserted into the cap element 10, a positive coupling is formed, which is set up by means of matched contours and/or interacting toothed structures.

FIG. 5 shows the coupling of the closure 31 to the cap element 10 that has taken place, in which the closure 31 is inserted into and surrounded by the cap element 10. With an arrow pointing downwards, a next possible coupling is indicated, in which the lid element 15 is placed on the cap element 10 and the closure 31. This can be done in a further step S5 in which, for example, the sleeve portion 154 of the lid element 15 is pushed between the cap element 10 and the closure 31 until the interlocking structures 113 and 153 engage and mesh, and the lid element 15 contacts the head portion 33 of the closure 31. Such force-transmitting contact between the lid element 15 and the closure 31 may be formed on the top surface 37 and/or on the outside or outer surface 35 of the closure 31.

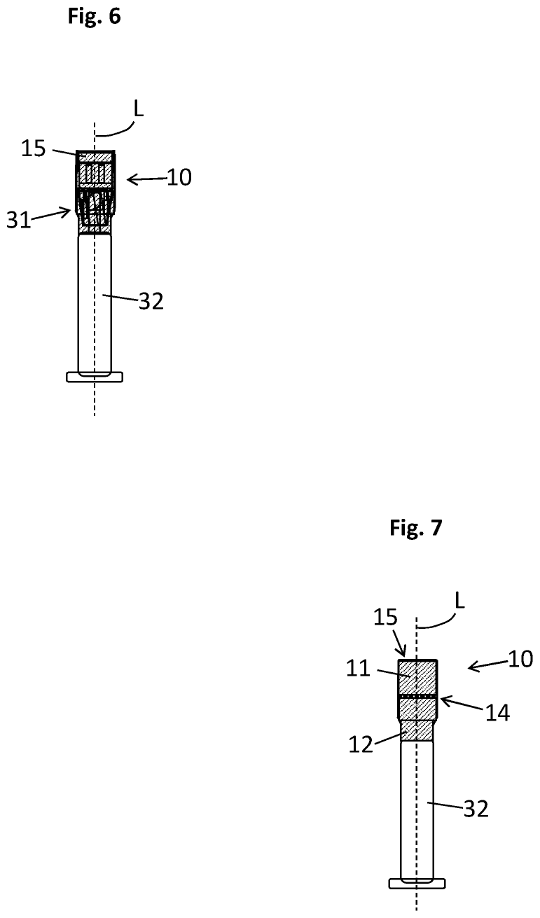

FIGS. 6 and 7 illustrate a condition of the system in which the cap element 10 and the lid element 15 are disposed on the container 30.

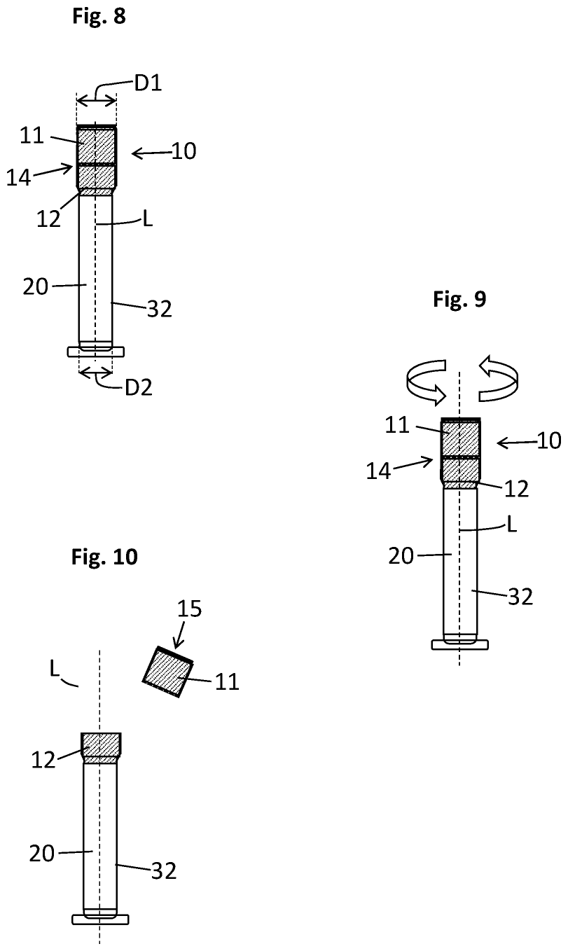

FIGS. 8 to 10 illustrate a fully arranged state of the labeling arrangement 1, in which the fixation label 20 is also arranged on the container 30. The fixation label 20 is attached to the syringe body 32 and the second cap portion 12 of the cap member 10 in a further step S6 of the method. The fixation label 20 is wrapped around the syringe body 32 and around the second cap portion 12 and has, for example, an adhesive layer on an underside thereof by means of which it is adhered to the respective components so that the first label portion 21 is adhered to the second cap portion 12 and the second label portion 22 is adhered to the syringe body 32. The fixation label 20 may form a wrap-around label or an over-round label, surround the circumference of the syringe, and partially come to rest on itself. Alternatively, the fixation label 20 is formed to cover only a circumferential portion of the surface 38 of the syringe body 32 and the outer surface 122 of the second cap portion 12.

The fixation label 20 serves as an identifying medium and may include lettering or printing indicating, for example, information regarding the contents of the container 30. In addition, the fixation label 20 is used to fix the threaded portion 34 in position and to prevent unwanted rotation of the threaded portion 34. The fixation label 20 couples the second cap portion 12, which in turn is coupled to the threaded member 34, to the syringe body 32 so that movement of the threaded member 34 relative to the syringe body 32 is resisted.

FIG. 8 further illustrates that by means of the cap element 10 and/or by means of the second cap portion 12 a circumferential equality of the adapted threaded part 34 and the syringe body 32 is achievable, so that a simple and wrinkle-free labeling of the adapted container 30 is possible. At least in a lower portion of the second cap portion 12 facing the syringe body 32, the cap element 10 has a diameter D2 substantially corresponding to a diameter of the cylindrical syringe body 32. In an upper portion of the second cap portion 12 and/or in the region of the first cap portion 11, the cap element 10 has, for example, a diameter D1 which is larger than the diameter D2, so that a geometry of the closure 31 is taken into account and, as it were, converted into an adapted cylindrical shape.

FIGS. 9 and 10 illustrate an opening process of the container 30, in which a rotational movement is performed on the upper, first cap portion 11, so that the cap element 10 tears or breaks open in the severing region 14. By means of applying force from the outside to the sleeve-shaped cap element 10 by applying pressure to the upper, first cap portion 11, a form fit can be formed which allows reliable force transmission to the head part 33 of the closure 31. The first cap portion 11 can thereupon be removed from the remaining components together with the lid element 15, if any, disposed thereon and the head part 33 of the closure 31 disposed therein. The severed cap element 10 now serves, in particular, as proof of opening and clearly visibly indicates that initial opening has occurred. Alternatively to embodiments of the labeling arrangement 1 with the lid element 15, it is also possible to provide the labeling arrangement 1 without a lid element 15 and further form a reliable initial opening indication for the container 30 and anti-rotation means for the threaded part 34.

FIGS. 11 and 12 show a further embodiment of the labeling arrangement 1, which comprises a two-part cap element 10, which are placed laterally around the closure 31 as indicated by the arrows and interlock with each other by means of a snap-in structure 16. In this regard, the cap element 10 may be closed at the top with the lid element 15 or may surround the closure 31 without a lid and form a sleeve that is open at the top.

FIGS. 13 and 14 show a further embodiment of the labeling arrangement 1, according to which the upper and lower cap portions 11 and 12 each have an interlocking structure 161 and 162 that interlock with each other and form a reliable hold. The lower, second cap portion 12 may also be referred to as a crown onto which the closure 31 is placed with the surrounding first cap portion 11 as a sleeve with or without a lid element 15, so that the engagement structures 161 and 162 interlock.

FIGS. 15 to 17 show a further embodiment of the labeling arrangement 1, according to which the cap element 10 is made in two parts in the form of crowns. The first cap portion 11 and the second cap portion 12 each have a crown shape and can be inserted into each other or arranged on top of each other. The separation or severing region 14 can then be formed between the two cap portions 11 and 12, which allows the upper crown to be removed from the lower one.

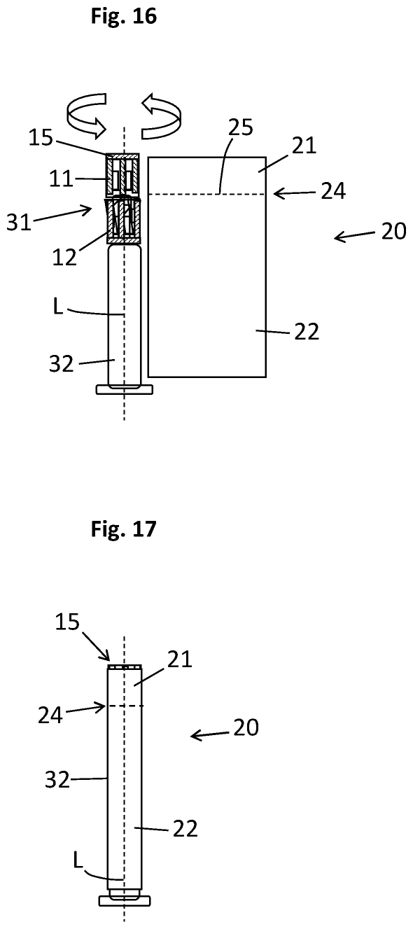

FIGS. 16 and 17 illustrate that the fixation label 20 is wrapped around the container 30 and the cap element 10 disposed thereon. In doing so, the fixation label 20 extends to the upper, first cap portion 11 and thus covers both crowns. Thus, by means of the fixation label 20, both cap portions 11 and 12 are coupled to the syringe body 32. According to this embodiment, the fixation label 20 has a severing region 24 comprising a perforation 25 that allows a predetermined severing of the fixation label 20 when the container 30 provided with the labeling arrangement 1 is opened. Preferably, an adhesive-free surface is formed in the severing region 24, so that a simple and low-resistance cutting through of the fixation label 20 and removal of the first label portion 21 is possible.

FIGS. 18 and 19 show a further embodiment of the labeling arrangement 1, according to which the cap element 10 is formed with an attached lid element 15. The lid element 15 is connected to the cap element 10 by means of a coupling element 17, for example in the form of a plastic strip. The coupling element 17 forms a mechanical joint, so that the lid element 15 can be placed on the cap element 10 when required and covers the upper side 37 of the closure 31.

FIGS. 20 to 22 show another embodiment of the labeling arrangement 1, according to which the first cap element 11 is configured as a tubular or foil element. Moreover, the lid element 15 is formed integrally with the first cap portion 11 and realizes a portion of the foil element covering the upper surface 37 of the closure 31. The first cap portion 11 thus forms, together with the lid element 15, a kind of foil pocket which is slipped over the closure 31 and coupled to the syringe 30 by means of the fixing label 20. In particular, the foil element can also be formed as a shrink foil which can be selectively shrunk and adapted to an outer contour of the enclosing elements by means of the action of heat radiation.

When the container 30 sealed with the labeling arrangement 1 is opened, the first cap portion 11 is severed or torn through by means of exerting pressure and turning on the head part 33 of the closure 31, so that a section of the first cap portion 11 with the head part 33 of the closure 31 can be removed from the syringe body 32. In this regard, the tearing may be performed along a predetermined tearing element or may be performed without a predetermined tearing position due to the thinly configured film element. According to such an embodiment, the severing region is not specifically located in the first cap portion 11 and is located between the second cap portion 12 and the upper side 37 of the closure 31.

FIGS. 23 to 25 show a further embodiment of the labeling arrangement 1, according to which the first cap portion 11 is configured as a shrink tube or shrink film element arranged on the second cap portion 12. By means of exposure to thermal radiation 19, the first cap portion 11 can be selectively shrunk and conform to the outer surface 35 and 36 of the closure 31. The fixation label 20 in turn fixes the second cap portion 12 and the threaded portion 34 fixedly disposed therein to the syringe body 32.

FIGS. 26 to 28 show a further embodiment example of the labeling arrangement 1, according to which, in contrast to the embodiment example according to FIGS. 23 to 25, a lid element 15 is present to which the first cap portion 11 is attached as a shrink tube or shrink film element. Attached to the closure 31 and inserted into the second cap portion 12, the first cap portion 11 can be shrunk by means of the action of heat radiation 19 and adapted to an outer shape of the closure 31 and, if necessary, also to an outer shape of the second cap portion 12 and, if necessary, also to an outer shape of the second cap portion 12.

FIGS. 29 to 31 show a further embodiment of the labeling arrangement 1, according to which the first cap portion 11 is formed with or without a lid element 15 as a fixed component and the second cap portion 12 is formed as a shrink tube or shrink film element. The second cap portion 12 is connected to the first cap portion 11 and is fitted onto the closure 31 and the container body 32. Subsequently, the second cap portion 12 is selectively shrunk by the action of heat radiation 19 to conform to an outer shape of the closure 31 and, if necessary, to an outer shape of the container body 32. The fixing label 20 is then fixed to the container body 32 and the cap element 10 in such a way that it rests with its first label portion 21 at least partially on the second cap portion 12 and fixes the cap element 10 to the container body 32.

In particular, the described embodiments of the labeling arrangement 1 enable a reliable Luer-lock closure 31 of a Luer-lock thread of a glass syringe 30, which is realizable with a very small diameter due to its construction, so that it hardly contributes to a widening of the glass syringe 30 but to a unification of the geometry of the glass syringe 30.

It is a finding in connection with the present invention that small glass syringes cannot be provided with a conventional secondary closure, since the primary closure has a larger circumference than the syringe body of the glass syringe in the case of a Luer-lock thread, and previous cap solutions, which are placed on the primary closure from above, protrude at an upper end of the syringe body as a result of this procedure. Among other things, this has a disadvantageous effect on labelability and on storage options for such adapted syringes. Due to different sized circumferences, the syringe body and such a secondary closure cannot be labeled together.

By means of the described labeling arrangement 1, circumferential equality from the syringe body 32 to the adjacent cap element 10 can be established in a simple and inexpensive manner Thereupon, the two components of syringe body 32 and cap element 10 can become reliably and wrinkle-free with a label and fix the closure 31 to the syringe body 32. Due to the preferred use of the labeling arrangement 1 on a glass syringe 30 with a Luer-lock thread, a kind of Luer-lock fix-click secondary closure can be realized by means of the labeling arrangement 1, which can be easily attached to the syringe 30 in a time-saving manner. In addition, by means of the labeling arrangement 1, it is helped that the adapted syringes 30 are not applied too broadly and continue to be nestable or storable in the storage containers provided for this purpose.

By means of the labeling arrangement 1, no additional connecting label is required to close a gap between an upper and lower cap or between the closure 31 and the syringe body 32 and to provide a first-opening indication, which may also be referred to as temper evidence. The cap element 10 forms a Luer-lock cap, which is attached to the syringe body 32 of the glass syringe 30 by means of the fixation label 20 and provides an anti-rotation feature with respect to the threaded portion 34 of the closure 31.

For the most part, the labeling arrangement 1 can be applied in a cleanroom-capable manner and enables the formation of a particularly small secondary closure diameter or a particularly small diameter application on the closure 31 of the syringe 30. Due to the described mounting options and cleanroom-capability, the labeling arrangement 1 further enables a more economical production process on the customer side. Furthermore, an opening of the adapted closure 31 and targeted destruction or separation of the cap portions 11 and 12 can be performed with a hand movement.

The cap element 10 realizes an elongated sleeve, the lower, second cap portion 12 of which preferably has the same outer diameter, at least in a lower region, as the syringe body 32 of the glass syringe 30. In particular, the closure 31 realizes a Luer-lock thread, which is inserted into the sleeve-shaped cap element 10. The Luer-lock thread interlocks with the lower part of the sleeve, which is realized by the second cap portion 12, so that a stable form fit is established. In particular, the cap element 10 is tapered in the inner portion of the second cap portion 12 and is adapted to an outer contour of the Luer-lock thread. By such a construction method, it is possible to form a smaller circumference in the lower region of the sleeve than in the upper region and, moreover, to form a circumference which has the same circumference as the syringe body 32. This has a particularly advantageous effect on a storage of the syringe 30 provided with the labeling arrangement 1.

An assembly of the labeling arrangement 1 can be carried out in such a way that first the entire closure 31 is inserted into the cap element 10 and subsequently the lid element 15, if present, is placed on the closure 31 from above. The lid element 15 is connected to the closure 31 of the syringe 30, for example, via a form-fit or force-fit on the inner surface 151. The outer surface 151 of the lid element 15 connects to the inner surface 111 of the cap element 10 via a form, force or substance fit. The connections ensure a rotational transmission of force from the sleeve-shaped cap element 10 to the closure 31 of the syringe 30. The described assembly steps can alternatively be performed in a different order.

A preferred embodiment of the labeling arrangement 1 may comprise the following assembly steps:
1. Coupling the assembly (cap element 10+closure 31+lid element 15) to the syringe body 32 of the glass syringe 30
2. Alternatively, coupling the cap element 10 to the assembly (closure 31+lid element 15) and to the syringe body 32 of the glass syringe 30
3. Alternatively: coupling the assembly (cap element 10+closure 31) to the syringe body 32 of the glass syringe 30 and to the lid element 15
4. Alternatively: coupling the syringe body 32 of the glass syringe 30 with the cap element 10 with the closure 31 and with the lid element 15
5. Alternatively: coupling the syringe body 32 of the glass syringe 30 with the cap element 10 and with the assembly (closure 31+lid element 15)

For example, at a supplier or in a pre-process, the following assembly steps may already be performed:
1a. Coupling the cap element 10 with the closure 31 and with the lid element 15 and thereby providing the assembly (cap element 10+closure 31+lid element 15)
1b. Coupling the cap element 10 with the assembly (closure 31+lid element 15) and thereby providing the assembly (cap element 10+closure 31+lid element 15).

In principle, the assembly operations according to 1. to 5. can be carried out in a clean room. The assembly according to one of steps 1a. or 1b., which has preferably already been pre-assembled at a supplier, can then be placed on the syringe body 32 of the glass syringe 30 in the clean room.

An opening operation of the syringe 30 applied with the labeling assembly 1 can be performed as follows: Via an externally acting angular momentum, the acting force is transmitted from the sleeve-shaped cap element 10 to the lid element 15, which in turn transmits the force to the head part 33 of the closure 31. During assembly, the lid element 15 preferably interlocks or connects with both the inner surface 111 cap element 10 and the outer surface 35 and/or the top surface 37 of the closure 31. If the acting force exceeds a holding force a perforation or existing connecting webs of the cap element 10, it separates into two halves of first and second cap portions 11 and 12. The upper, first cap portion 11 remains interlocked with the lid element 15, which in turn dwells on the head part 33 of the closure 31. The lower, second cap portion 12 of the cap element 10 fixes the lower Luer-lock thread or threaded portion 34 closure 31 and remains connected to the syringe body 32 of the glass syringe 30 via the fixation label 20.

List of reference signs

| | |
|---|---|
| 1 | labeling arrangement |
| 10 | cap element/secondary cap |
| 11 | first/upper cap portion |
| 111 | inner surface of first cap portion |
| 113 | interlocking structure of first cap portion |
| 12 | second/lower cap portion |
| 121 | inner surface of second cap portion |
| 122 | outer surface of second cap portion |
| 123 | engagement hook of second cap portion |
| 14 | severing region of the cap element |
| 141 | perforation/connecting webs |
| 15 | lid element |
| 151 | inner surface of lid element |
| 152 | outer surface of the lid element |
| 153 | interlocking structure of lid element |
| 154 | sleeve section of cap element |
| 16 | snap-in structure of cap element |
| 161 | engaging structure of first cap portion |
| 162 | engaging structure of second cap portion |
| 17 | coupling element |
| 19 | heat radiation |
| 20 | fixation label |
| 21 | first/upper label portion of the fixation label |
| 22 | second/lower label portion of the fixation label |
| 24 | severing region of the fixation label |
| 25 | severing element/perforation |
| 30 | container/syringe |
| 31 | closure/primary cap |
| 32 | container body/syringe body |
| 33 | head part of closure |
| 34 | threaded part of the closure |
| 35 | outer surface of the head part of the closure |
| 36 | outer surface of the threaded part of the closure |
| 37 | top part of the closure |
| 38 | outer surface of the body of the container |
| D1 | first/upper diameter |
| D2 | second/lower diameter |
| L | longitudinal axis |
| S(i) | step of a method of applying a labeling arrangement |

1. A labeling arrangement (1) for a multi-part container (30), comprising:
a sleeve-shaped cap element (10) having an interlocking structure on an inner surface (111, 121) and adapted to be coupled to and surround an outer surface (35, 36) of a closure (31) of the container (30) by means of the interlocking structure, the cap element (10) having, with respect to a longitudinal axis (L), a first cap portion (11), a second cap portion (12), and a severing region (14); and
a fixation label (20) having a first label portion (21) and a second label portion (22) adjacent to the first label portion (21), the first label portion (21) being adapted to be attached to the second cap portion (12) and the second label portion (22) being adapted to be attached to a body (32) of the container (30) such that the fixing label (20) couples the cap element (10) to the container body (32), so that when the container (30) applied with the labeling assembly (1) is opened, the cap element (10) is separable in the severing region (14) and at least a part of the first cap portion (11) is removable together with a part (33) of the closure (31) from the second cap portion (12) and the container body (32).

2. The labeling arrangement (1) according to claim 1, wherein the second cap portion (12) is arranged adjacent to and geometrically formed in coordination with the container body (32) with respect to a condition of the labeling arrangement (1) applied to the container (30) and has a predetermined circumferential geometry.

3. The labeling arrangement (1) according to claim 2, wherein the cap element (10) is rotationally symmetrical in coordination with the container (30) with respect to the longitudinal axis (L) and at least the second cap portion (12) has a predetermined diameter (D2) corresponding to a diameter of the container body (32), so that an outer surface (122) of the second cap portion (12) can be arranged flush with an outer surface (38) of the container body (32).

4. The labeling arrangement (1) according to claim 1, wherein, with respect to the longitudinal axis (L), the first and/or the second cap portion (11, 12) has, on a respective inner surface (111, 121), a circumferential contour which forms a negative shape with respect to a circumferential contour on a respective outer surface (35, 36) of the closure (31).

5. The labeling arrangement (1) according to claim 1, wherein a wall of the second cap portion (12) is cone-shaped with respect to the longitudinal axis (L) and tapers towards the first cap portion (11).

6. The labeling arrangement (1) according to claim 1, comprising:
a lid element (15) which is couplable to the first cap portion (11) and which is adapted to be fixed to the closure (31) of the container (30) and to couple the first cap portion (11) to the closure (31) and to cover an upper side (37) of the closure (31).

7. The labeling arrangement (1) according to claim 6, wherein the lid element (15) is configured to be coupled to the first cap portion (11) and/or the closure (31) in a form-fit, force-fit and/or material-fit manner.

8. The labeling arrangement (1) according to claim 7, wherein the first cap portion (11) comprises, on an inner surface (111), a contour with a toothed structure (113) which is formed in a predetermined manner in coordination with a contour with a toothed structure (153) on an outer surface (152) of the lid element (15).

9. The labeling arrangement (1) according to claim 7, wherein the first cap portion (11) and the lid element (15) can be coupled to each other by means of welding and/or gluing.

10. The labeling arrangement (1) according to claim 6, wherein the lid element (15) comprises a sleeve portion (154) arranged between the cap element (10) and the closure (31) with respect to a state of the labeling arrangement (1) applied to the container (30).

11. The labeling arrangement (1) according to claim 1, wherein the cap element (10) and/or the lid element (15) are designed as a shrink film element.

12. The labeling arrangement (1) according to claim 1, wherein the first and second cap portions (11, 12) are connected to each other and the severing region (14) is formed between the first and second cap portions (11, 12) with respect to the longitudinal axis (L), so that, when the container (30) applied with the labeling arrangement (1) is opened, the cap element (10) can be cut through in a predetermined manner in the severing region (14) and the first cap portion (11) can be removed together with a part (33) of the closure (31) from the second cap portion (12) and the container body (32).

13. The labeling arrangement (1) according to claim 1, wherein the cap element (10) comprises, in the severing region (14), a severing element (141) in the form of a perforation and/or in the form of a plurality of connecting webs.

14. The labeling arrangement (1) according to claim 1, wherein the second cap portion (12) has a latching hook (123) which is arranged to form a form-fitting coupling with the closure (31) of the container (30), so that, with respect to the longitudinal axis (L) of the cap element (10), a retaining force can be established between the cap element (10) and the closure (31) in the direction of the longitudinal axis (L).

15. The labeling arrangement (1) according to claim 1, wherein the severing region (14) is formed in coordination with the container (30) in an area of the cap element (10) which, in an applied state of the labeling arrangement (1) to the container (30), is associated with a transition between a head part (33) and a threaded part (34) of the closure (31).

16. The labeling arrangement (1) according to claim 1, comprising:
an opening detection element (141) arranged in the severing region (14) of the cap element (10) and adapted to indicate a removal of at least a portion of the first cap portion (11) together with the part (33) of the closure (31) from the container body (32) upon an opening of the container (30) applied with the labeling arrangement (1).

17. A use of the labeling arrangement (1) according to claim 1 for a container (30) divisible into a plurality of parts, comprising a container body (32) and a closure (31) coupleable to the container body (32).

18. A system, comprising:
a container (30) divisible into a plurality of parts, having a container body (32) and a closure (31) coupleable to the container body (32); and
the labeling arrangement (1) according to claim 1, which is applied to the container (30) in such a manner that the cap element (10) surrounds the closure (31) and the first cap portion (11) is associated with a head part (33) and the second cap portion (12) is associated with a threaded part (34) of the closure (31), and that the first label portion (21) of the fixing label (20) is attached to the second cap portion (12) and the second label portion (22) of the fixing label (20) is attached to the container body (32) such that the fixation label (20) couples the cap element (10) to the container body (32).

19. A method of attaching a labeling arrangement (1) to a multi-part container (30), comprising:
providing a container (30) divisible into a plurality of parts, comprising a container body (32) and a closure (31) coupleable to the container body (32),
providing the labeling arrangement (1) with a sleeve-shaped cap element (10) and a fixation label (20), wherein the cap element (10) has a first cap portion (11), a second cap portion (12), and a severing region (14), and wherein the fixation label (20) has a first label portion (21) and a second label portion (22) adjacent to the first label portion (21),
coupling the cap element (10) to the container body (32) and to the closure (31) of the container (30) such that the cap element (10) is attached to the container body (32) and surrounds the closure (31),
attaching the fixation label (20) to the container (30) by attaching the second label portion (22) to the container body (32), and
attaching the fixation label (20) to the cap element (10) by attaching the first label portion (21) to the second cap portion (12) such that the fixation label (20) couples the cap element (10) to the container body (32), such that when the container (30) applied with the labeling arrangement (1) is opened, the labeling arrangement (1) is separable in the severing region (14) and at least a part of the first cap portion (11) together with a part (33) of the closure (31) is removable from the second cap portion (12) and the container body (32).

20. The method of claim 19, wherein coupling the cap element (10) to the container body (32) and to the closure (31) comprises:
placing the sleeve-shaped cap element (10) on the container body (32); and
inserting the closure (31) into the sleeve-shaped cap element (10).

21. The method according to claim 20, wherein inserting the closure (31) into the cap element (10) is performed subsequent to placing the cap element (10) on the container body (32).

22. The method according to claim 19, wherein the labeling arrangement (1) comprises a lid element (15), comprising:
placing the lid element (15) on the first cap portion (11) of the cap element (10) and/or on a head part (33) of the closure (31), so that the lid element (15) covers an upper side (37) of the head part (33) of the closure (31) and, when the container (30) applied with the labeling arrangement (1) is opened, the lid element (15) couples the first cap portion (11) with head part (33).

23. The method according to claim 19, wherein the cap element (10) and/or the lid element (15) are coupled to the closure (31) in a form-fitting, force-fitting and/or substance-fitting manner.

24. The method according to claim 23, in which the cap element (10) and/or the lid element (15) are coupled to the closure (31) by means of interlocking, by means of adhesive bonding, by means of welding and/or by means of the action of thermal radiation.
